(19) United States
(12) Patent Application Publication
(10) Pub. No.: US 2002/0029272 A1
(43) Pub. Date: Mar. 7, 2002

(54) Method and system for assigning and distributing work over a computer network

(76) Inventor: Scott Weller, Marshall, MI (US)

Correspondence Address: MICHAEL TAVELLA, 2051 BRIGADIER DRIVE, ANCHORAGE, AK, 99507, US

(21) Appl. No.: 09/780,893

(22) Filed: Feb. 9, 2001

Related U.S. Application Data
(60) Provisional application No. 60/181,740, filed on Feb. 11, 2000.

(51) Int. Cl. G06F 15/173

(52) U.S. Cl. 709/226

(57) ABSTRACT

The invention is a method and system for aligning a properly skilled external work force with a workflow task for a particular while maintaining control and quality assurance over the work product created for the business by the external workforce. The system enables the assignment and distribution of work via a computer network from a business customer having a particular task that requires a particular skill set, matching that to one or more agents over a computer network, and collecting and assimilating the at least a portion of the final work product for retrieval by the customer.

### CROSS REFERENCE TO RELATED APPLICATIONS

This patent application claims priority under U.S. Provisional Application No. 60/181,740, filed Feb. 11, 2000.

### STATEMENT REGARDING FEDERALLY SPONSORED RESEARCH AND DEVELOPMENT

Not Applicable

### BACKGROUND OF THE INVENTION

1. Field of the invention

The invention relates to a method and system for assigning and distributing work over a computer network, and, more particularly, to assigning work from a requesting customer to pre-qualified independent contractors/agents, providing the prequalified independent contractors/agents with a profile of the work product, and returning a completed work product to the customer through an internet database accessed through a customizable interface.

2. Description of the Related Art

For a variety of reasons, many businesses have a need for an external work force. In some situations, the business lacks a particular expertise and seeks out a consultant or another with the particular expertise has the external workforce to satisfy the current need. In a production oriented or data collection environment, many businesses have peaks in their workloads, which they address by tapping into the external workforce to avoid permanently increasing their internal workforce. Some business philosophies are based on minimizing the internal workforce and relying solely on an external workforce to minimize or eliminate the administration inherent with an internal workforce. In times of low unemployment, many businesses must use outside workers for economies of scale. Regardless of the reasons, businesses more frequently turn to external workforce to satisfy their ongoing, long-term, and short-term business needs.

The reliance on external workforce can have problems. Some of the major problems encountered by business when relying on an external workforce are: obtaining an external workforce with the proper skills, insuring the quality of the external workforce, obtaining the needed quantity, and providing unified national network of the external workforce. Businesses often have no choice but to spend a great deal of resources to find a suitable external workforce for a particular project. The more resource required to find a suitably skilled external work force, reduces the benefit to the business of using an external workforce.

The increased importance of quality of life has generated an often overlooked and untapped external workforce of highly skilled and highly competent workers who shop their skills as agents, independent contractors, part-time employees, and project-basis employees. These workers, stay at home parent and retired professions typically require a greater degree of control over their time commitments than those employed in more conventional business settings.

Many of these workers shop their skills to business through temporary agencies or through consulting firms. Unfortunately, the temporary agencies and consulting firms still face substantial barriers in aligning the workers with the proper skills to the business and desire of those skills and providing the necessary quantity of workers. Many of these barriers are geographical and communication based. It is unlikely and almost process prohibitive for a business to contact multiple individuals or consulting agencies throughout the country and select from them an external workforce having the desired skill and in the desired quantity, especially when the desired external workforce must be highly skilled.

One solution to the problem of overcoming the barriers to aligning a suitably skilled external workforce with a particular business can be found in an Internet based approach at the website freeagent.com. Freeagent.com receives work assignments from various customers who provide a detail skill requirement for the work assignment. Freeagent.com attempts to match the work assignment and its required skills with a database of agents having a known skill set. If a suitable match is found, the business and the agent are introduced and left to their own to resolve the parameters of their working relationship, independent of freeagent.com. If there are multiple suitable independent contractors, each can sign up for the same work task. The client shoulders the burden of interviewing and selecting from the multiple agents. The work product is distributed between the business and the agent, is passed directly between the business and the agent, and is not distributed through the freeagent.com database or system. In essence, the freeagent.com system merely brings together or matches a suitably skilled agent with a business, much like an electronic temporary agency. In many types of business, such as telemarketing, sales and consumer surveys, it is highly desired for the work product to be handled through a centralized location where the business is not only matched with an appropriate external workforce, but the work product is distributed through a centralized control point to compile the collective work product of one or more agents along with insuring the timely completion of the project without adding additional burden to the business requesting the external workforce.

### BRIEF SUMMARY OF THE INVENTION

The invention addresses the problems of aligning a properly skilled external work force with a particular business and its current workflow task while maintaining control and quality insurance over the work product created for the business by the external workforce. The invention relates to a method and system for assigning and distributing work over a computer network from a business customer having a particular task that requires a particular skill set, matching that to one or more agents over a computer network, and collecting and assimilating the at least a portion of the final work product for retrieval by the customer.

The customer and agent access the task and completed projects through an information center. The information center receives the task from the customer and informs a suitable agent of the task. Once the task is properly staffed by accepting agents, the task is made unavailable to other suitable agents. The agents complete the task and distribute their work product to the customer through the information center

The distribution and control of the task for multiple agents within the network provide a workflow supply and demand method of task allocation that agents can accept or deny potential tasks for completion and reporting. The control to find a suitable agent is the responsibility of the information center based on the task profile. The task management distribution system permits qualified agents the means to accept the terms of the posted task. Once a task is accepted by the viewing agent, the other qualified agents will not be able to accept the same task. The customers that posted the task do not have to resource against interviewing and sustaining paper work on the independent contractors.

Multiple qualified agents can review the task, creating competition to accept the task for near real-time results. The acceptance competition will create a task distribution market. Agents can pursue accepting and retrieving the posted tasks that meet the needs of their schedules. Account status for and billing with proper identification for both the customer and agent. Billing and payments will occur after the task is completed.

### BRIEF DESCRIPTION OF THE DRAWINGS

FIG. 1 is a schematic representation of the method and system for assigning and distributing work over a computer network comprising a customer pool and agent pool connected to an information center.

FIG. 2 is a schematic representation of an Internet-based implementation of the system of FIG. 1.

FIG. 3 is a schematic representation of the database and interface components of the information center of FIG. 1.

FIG. 4 is a flow chart illustrating the major process steps in the method and system according to the invention.

FIG. 5 is a flow chart illustration the major process steps for the acquisition of agent information.

FIG. 6 is a flow chart illustration the major process steps for the acquisition of customer information.

FIG. 7 is a flow chart illustration the major process steps for the acquisition of task information.

FIG. 8 is a flow chart illustration the major process steps for matching the agent profiles with a particular task profile.

FIG. 9 is a flow chart illustration the major process steps for agents acceptance of a task.

FIG. 10 is a flow chart illustration the major process steps for distributing the material for completing the task.

FIG. 11 is a flow chart illustration the major process steps for compiling the task results.

### DETAILED DESCRIPTION OF THE INVENTION

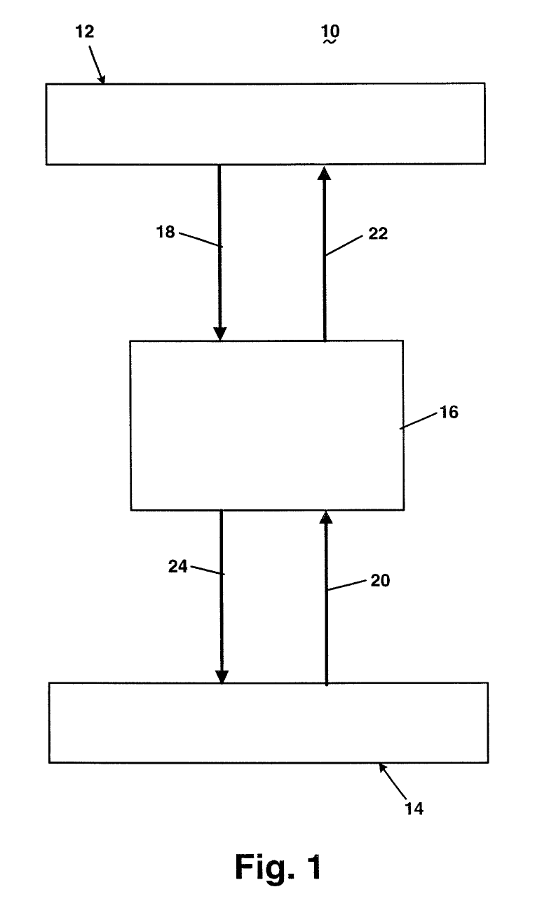

FIG. 1, schematically illustrates the system 10 for assigning and distributing work over a computer network according to the invention. The basic components of the system 10 comprises a customer pool 12 and a workforce pool 14 that are networked together through a information center 16 used to control information center of the work product 16. The customer and workforce pools 12, 14 are bi-directionally connected to the information center 16 by input connections 18, 20 and output connections 22, 24, respectively. The input connections 18, 20 permit the customer pool 12 and workforce pool 14 to send data to information center. Similarly, the output connections 22, 24 permit communication from the information center 16 to the customer and workforce pools 12, 14.

It is contemplated that the customer pool 12 will comprise one or more customers who have one or more tasks that the customer desires to be completed by an external workforce. The customers can include any type of business from large corporations to individuals.

The workforce pool 14 includes one or more agents with a particular skill set and of a known quality. The agents can be individuals or groups of individuals. It is preferred that the agents be unaffiliated individuals and have an independent contractor relationship of the information center. These independent contractors will be knowledgeable within different work task categories.

An overview of the operation of the system 10 will be helpful prior to a more detailed description. Each of the customers in the customer pool 12 inputs a customer profile to the information center 16 through the input connection 18. The customer profile contains relevant information that includes, but is not limited to, customer name, business type, contact information, and financial information. The customer profile can also include information provided from the information center submitted by others than the customer. For each task, a customer inputs a task profile to the information center 16. The task profile includes but is not limited to; task name, task deadline, task description, agent skill requirements, pay requirements, and attached materials needed to complete the task.

Each of the agents in the workforce pool 14 input an agent profile into the data collection in distribution hub 16. The agent profile includes relevant agent information, including, but not limited to, name, contact information, skill set, work history, and performance reviews. The agent profile can also include information provided by the information center 16, for example, performance reviews by a previous customer.

To initiate the completion of a task, a customer in the customer pool 12 fills out a task profile and inputs it into the information center 16 through input connection 18. The task profile is compared with all available agent profiles to determine suitable matches in the required skill set. The task is communicated to the matching agents, preferably by making the task profile available for viewing by the suitable agents through customizable interface at the information center 16. The information center can also distribute the task for a variety of reasons such as workload, timing, geographical area, and authorization. The task can also be communicated to the suitable agents by other methods such as sending an e-mail, or ringing a beeper, for example. The various methods of communicating the task to the suitable agents are not necessary exclusive.

Once the task is communicated to the matched agents, the agents can then accept and/or deny the task by inputting the acceptance or denial to the information center 16. If the agent accepts the task, then the information center 16 communicates to the remaining suitable agents the change in status of the availability of the task and distributes all necessary materials including templates and forms to the accepting agent for initiation of the task. Once an agent pulls the task, the terms of the contract are solidified. Since multiple qualified agents are cleared by the information center to retrieve the task, the present invention will promote agent competition for the posted task. A market place task pulling competition will result for best jobs. The communication to the nonaccepting agents can be done in the same manner as communicating the availability of the task. For example, the task can be removed from the user interface residing on the information center 16 inaccessible by the workforce pool 14, by e-mail, pager, or beeper. As the accepting agent completes portions of, or the entire task, the completed portions and task are inputted into the information center by the agent. The input of the completed task and any sub-portions can be accomplished in many different ways. For example, the accepted agent can upload electronic files to the information center for subsequent retrieval by the customer. The accepted agent could complete a form residing on the information center 16. Once the accepted agent has completed a portion of or the entire task, the completion is communicated to the customer, who can then access and/or retrieve the completed task or task portions as the case may be.

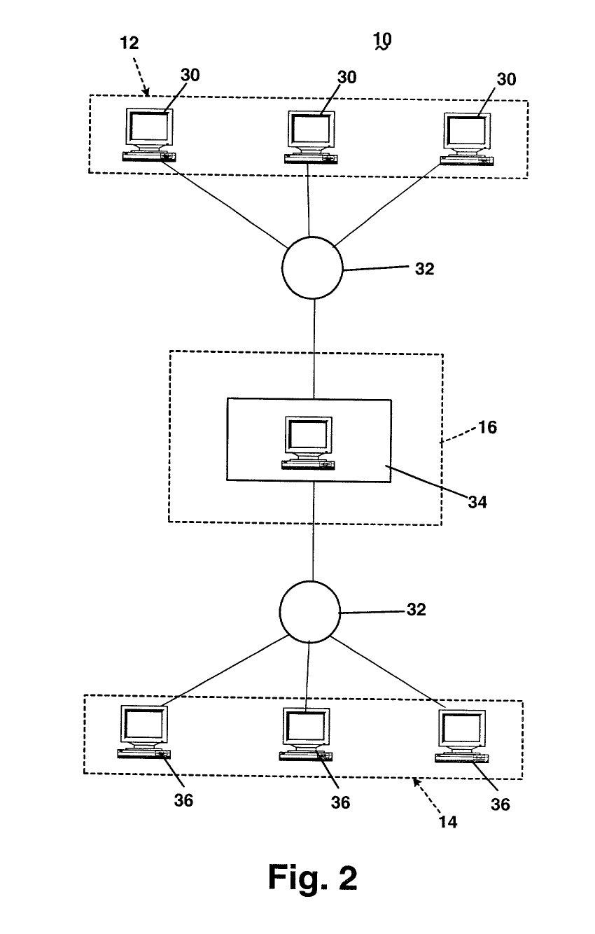

FIG. 2 illustrates a preferred implementation of the system 10 for assigning and distributing work over a computer network. The customer pool 12 comprises multiple customer terminals 30 each connected to an internet server 32, which is connected to a web server 34 in the information center 16 containing multiple databases and a user interface. In a similar manner, the work force pool 14 comprises multiple agent terminals 36 connected to an Internet server 32, which is connected to the web server 34.

It is worth noting that the customer and agent terminals 30, 36 and the web server34 can be a single computer or a network of computers all connected to the Internet servers 32. The connection between the customer and agent terminals 30, 36, web server to the Internet server can be any suitable connection, such as a dial-up connection with a modem and a direct connection. The connection between the Internet server and the web server 34 is preferably a continuous connection.

The customer and agent terminals 30, 36 will run a suitable software for accessing the databases on the web server 34. Preferably, the customer and agent terminals 30, 36 each use a web browser capable of reading web pages, preferably in an html format. Similarly, the user interface and databases on the web server 34 preferably are accessible to and can be queried by the web browsers. The web server can include active server pages, permitting the real time updating of the information from the databases to either the customer or agent terminals 30, 36.

It should be noted that although the preferred implementation of the system 10 is an internet-based system, it is within the scope of the invention for the implementation to be conducted on a traditional computer network, such as a local area network (LAN) or a wide area network (WAN). Also, the system could be implemented on a stand-alone computer housing a web server with all of the customer and agents connecting through direct dial-up access.

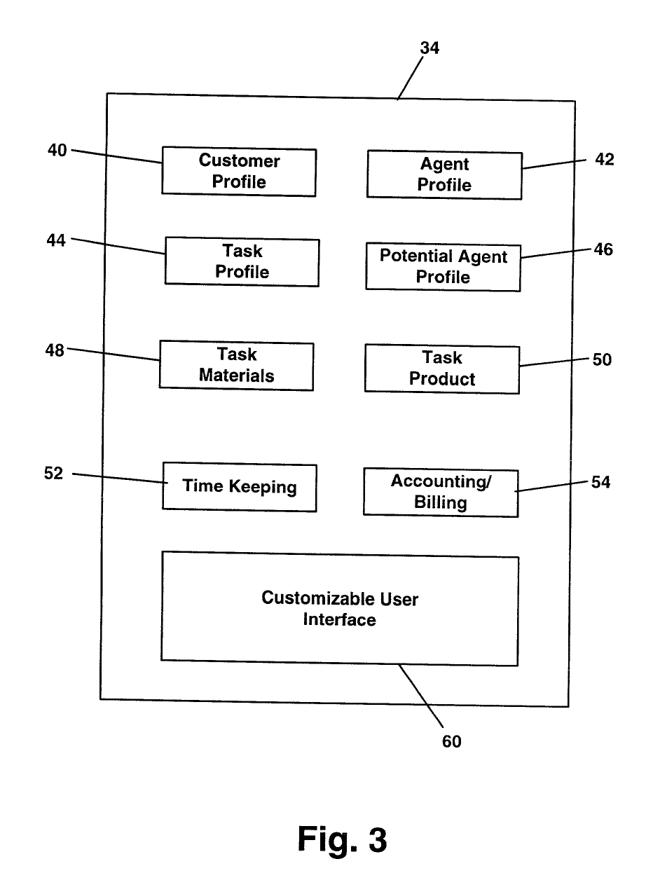

Referring now to FIG. 3, the structure of the databases for the web server 34 of the information center is schematically illustrated. The web server 34 preferably comprises a customer profile database 40 in which is stored all of the customer profile information. Similarly, an agent profile database 42 stores all of the agent profile information. A task profile database 44 stores all of the relevant task information needed to match a particular task with a particular agent. An optional potential agent profile database 46 can be provided to store profile information for agents who have not been screened.

A task materials database 48 stores various materials related or necessary to completing a particular task. For example, the task materials database can include a script and corresponding instructions for a telemarketing task, blank forms for a survey task, along with contact lists and any other type of information needed to complete a task. A task product database 50 is provided for storing the portions of or an entire completed task.

The web server also includes a time keeping database 52 and an accounting and billing database 54, which are used by the information center for tracking the agents time and billing the customer for the work. Many other traditional back-office applications can be stored on the web server.

A customizable user interface 60 permits the customers and agents to access the relevant portions of the various databases contained on the web server. Preferably, the interface 60 is an encrypted and password protected web site requiring a user ID to logon. The requirement for the customers and agents to have a logon ID and preferably a combination of a log on ID and password permits the interface 60 to be customized for a particular customer or agent with specific information relevant to that particular customer or agent.

The interface 60 provides for a particular customer or agent to access data related to current tasks, new tasks, and previous tasks for the particular agent or customer. The interface is also used for new customers and new agents to fill out the appropriate customer profile, agent profile, and task profile.

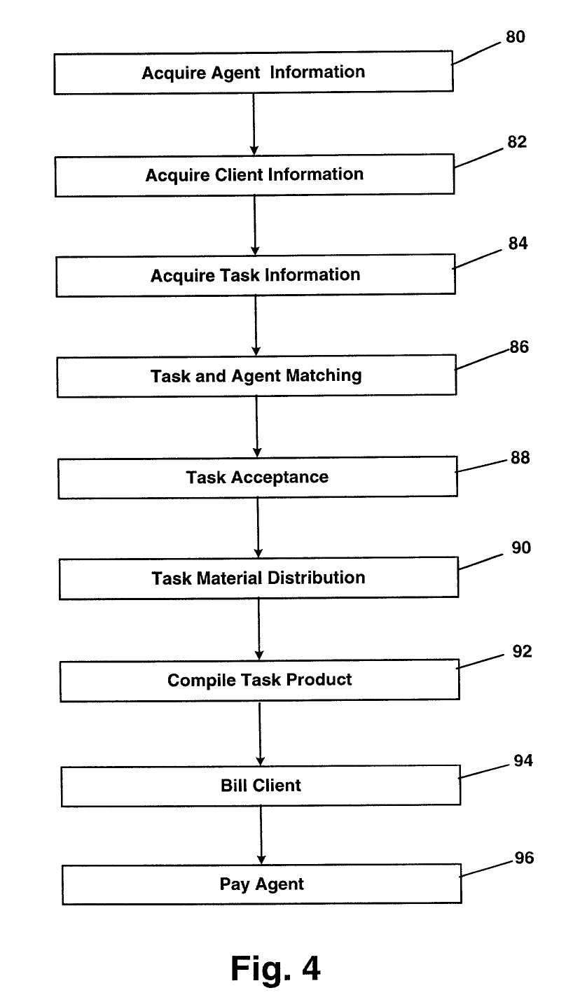

FIG. 4 illustrates the major process steps in implementing the task assignment and distribution system 10. Initially, the relevant agent and customer information is collected and stored in the corresponding customer and agent profile databases 40, 42 at steps 80, 82. The agent and customer information input steps can include updating information on current agents and customers. Preferably, the agent and customer input steps include an acceptance or confirmation step in which the skills and quality of the agent are confirmed and the reputation and financial background of the customer are confirmed

The agent and customer profiles are filled out through the interface 60. Preferably, the interface includes multiple forms requiring agent or customer input responsive to multiple questions, with each of the questions pertaining to the relevant parameters for the agent or customer as the case may be. The forms are preferably web-based forms linked to the appropriate database so that the information supplied on the form when submitted is written to the appropriate database.

The methods of programming internet-based database forms for inputting data into an Internet database are well-known and available to one of ordinary skill in the art. The particular method is not of great importance to the invention and will not be described in detail for this step or any other.

Once the customer information is acquired in step 82, the customer can then input or upload a task to the information centerl6 in step 84. The task information is preferably completed by completing a form containing the desired and necessary task information. The completed task form is saved to the task profile database 44 as a unique task profile.

Upon the completion of the task profile, the agent profile information and task profile information are compared for matches in step 86, especially a match in the required skills for the task and the skills of the agent. The task is communicated to all of the matching agents through the interface 60 or by any other suitable means. Each matching agent has the opportunity to accept the task in step 88. Once an agent accepts a task, the task profile database is updated and subsequent agents are not permitted to accept the task, unless the task requires multiple agents.

Once an agent has accepted the task, the corresponding task materials are distributed to the agent in step 90. The agent then uses the task materials to complete a portion or the entire task. As the task is being completed by the agent, the task product is compiled in step 92 and made accessible to the customer, preferably through the interface 60. If a task were split between multiple agents from the same manufacturer, the results via the task code would be consolidated within a customer report.

When the task is fully completed, the customer is billed for the agent services in step 94 by the information center 16 and the agent is paid by the information center 16 at step 96 upon receipt of payment by the information center 16.

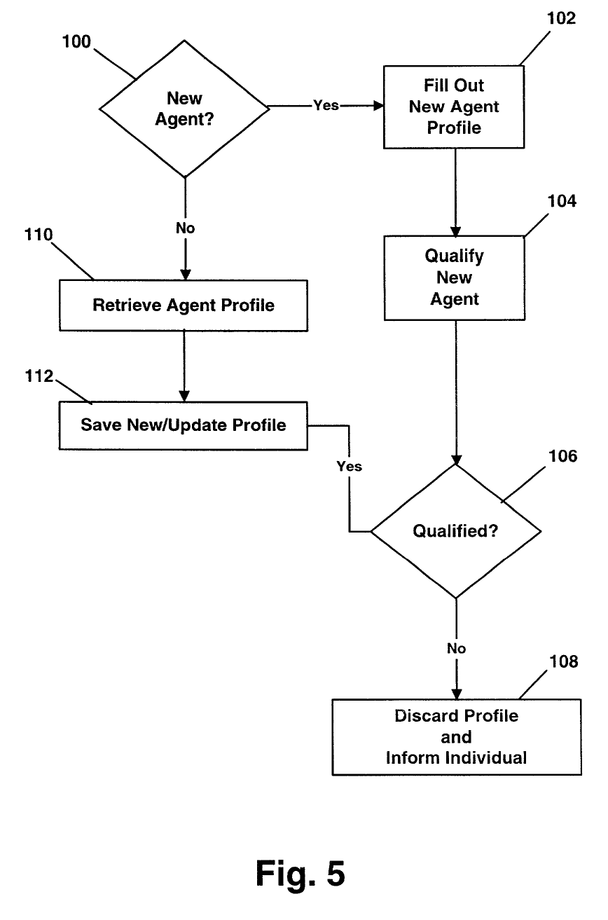

Each of the major steps of FIG. 4 is described in detail in FIGS. 5-11. FIG. 5 illustrates the major steps of the acquisition of the agent information 80. Initially, a determination is made if the agent is a new agent or a current agent. In the case of a new agent, the new agent is required to fill out a new agent profile 102. The completed new agent profile is then subject to a qualifying review 104 to ensure the quality of the new agent. If the new agent does not qualify, the new agent profile is discarded 108. If the new agent is qualified, the new agent profile is saved 112.

If it turns out that the individual is not a new agent, the agent's profile is retrieved 110 and the agent is permitted to update his profile. The updated profile is then saved 112. Although not shown, it is an option that the updated profile may be subject to a re-qualification in the same enter as a new agent profile.

The acquiring of the agent information 80 is preferably accomplished through the interface 60. The determination of whether or not the individual is a new agent 100 is accomplished by the individual accessing a web page on the web server 34 that can have a new agent hypertext link and/or a login form. If the individual goes to the new agent link or tries to enter the logon with an invalid logon or password, it can be assumed that the individual is a new agent and they are directed to a new agent profile web page form than can be filled out to complete the new agent profile 102. When the new agent web page form is completed and submitted, it is saved in the agent profile database 42. Alternatively, the new agent profile could be saved in the potential agent profile database until the individual is qualified. Upon qualification, the new agent profile would then be moved from the potential agent profile database 46 to the agent profile database 42.

In either case, if the new agent is not qualified, the new agent profile will be removed from the agent profile database 42. Optionally, the unqualified new agent profile can be left in the potential agent profile database 46. The unqualified new agent is then informed of their status, preferably by e-mail.

The qualifying of new agents 104 can take on many forms. The qualifying step will typically include confirmation of the new agent's professional licenses, educational background and skill set as identified in the new agent profile. The qualifying step 104 may also include requiring the agent to take various standardized tests, which may conducted online through the interface or at an offline testing center. The type and manner of qualification can depend on the particular skill set identified by the new agent.

Returning to the new agent determination 100, if it is determined that the individual is not a new agent, preferably by the individual entering the interface 60 with a valid logon I.D. and password if required, the agent is directed to a new web page containing their previously completed agent profile that is retrieved from the agent profile database 42. The agent can then alter any of the information on the agent profile. Upon completion of the update to the agent profile, the updated agent profile form is saved to the agent profile database 42.

It is worth noting that in the preferred model, the agents are employees of the information center 16. Therefore, to effect the employee/employer relationship, the new agent profile may include an employment agreement along with the terms and conditions of employment. Alternatively, an additional step to qualifying the new agent would be to distribute employment forms to the new agent for the new agent's execution and return to the information center.

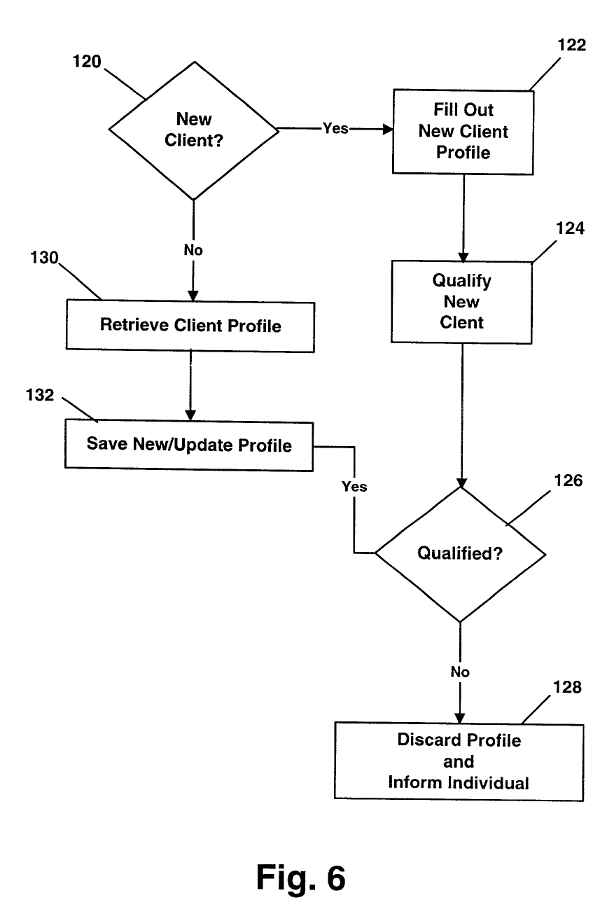

FIG. 6 illustrates the major steps in acquiring customer information 82, which closely parallels the steps of acquiring the agent information. Initially, a determination is made whether or not the customer is a new customer 120. If it is a new customer, the new customer is directed to fill out the new customer profile 122 that is subject to qualification at step 124. If the customer is not qualified at 126, the new customer profile is discarded 128 and the potential new customer is informed. If the new customer is qualified, the new customer profile is saved to the customer profile database 40.

If the customer is not a new customer, the customer's profile is retrieved at 130 and the customer is permitted to update the customer profile information. The updated customer profile information is then saved 132 to the customer profile database 40.

As with the acquisition of the agent information, the acquisition of the customer information is preferably obtained by the customer or potential customer accessing the interface 60. The new customer determination 120 is made by the new customer checking a new customer link on the customer logon web page or entering an invalid logon I.D. in the logon I.D. form. The new customer is then directed to a new web page containing a form for new customer information, which is submitted for qualification at 124. If the customer is not new, the valid logon I.D. is used to retrieve the customer profile from the customer profile database 40 and display it on the interface 60 where the customer can update the customer profile information as desired. The updated customer profile form is then saved to the customer profile database 40.

The qualification steps for a new customer are typical for any business. A new customer's financial history and credit worthiness may be checked along with the reputation of the new customer. The qualification step may also be applied as desired to an updated customer profile.

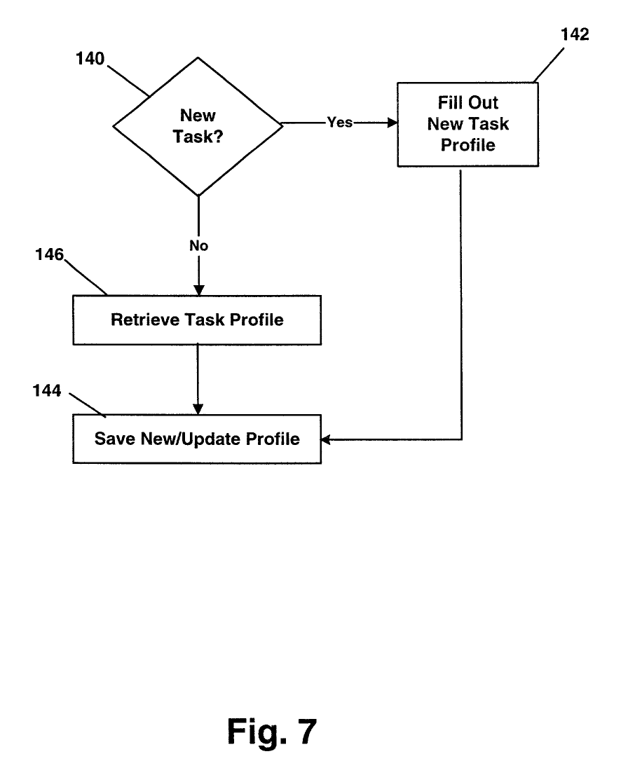

FIG. 7 illustrates the major steps in acquiring task information 84. Initially, a determination is made if the task is a new task 140. If the task is new, a new task profile is completed at 142 by the customer. The new task profile is then saved to the task profile database 44 for subsequent display on the interface 60. If the task is not new, the task is retrieved from the task profile database 44, where the user can alter any of the task profile parameters. Once the task profile is updated, it is saved to the task profile database 46.

To acquire the task information 84, it is preferred that the customer first logon to the information center 16 through the interface 60 by using a valid logon I.D. The interface 60 will present the customer with a new task link or an update task link. Instead of an update task link, the interface 60 can disclose links to all of the current tasks for a particular customer, and the customer need only select the task that needs updating. If the customer selects the new task link, the customer is redirected to a new task profile form on a different web page. Once the customer completes the new task profile form and submits it, the task profile is saved to the task profile database 44, where it is subject to the agent matching process at step 86.

If the update task link is selected, the customer is directed to a new web page of the customer's current tasks. The customer can then select the desired task for updating, which retrieves the task profile information from the task profile database 44 and displays it in a new web page as a filled out task profile form. The customer then updates the desired information and resubmits the form, which is then saved at 144 to the task profile database 44.

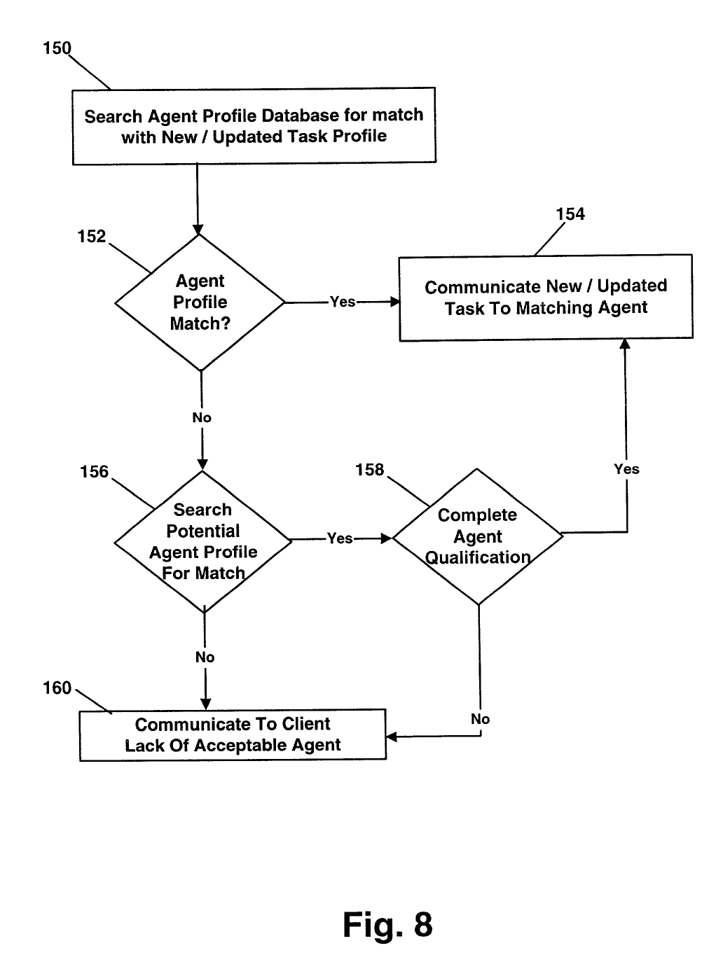

FIG. 8 illustrates the major steps of matching a task profile to an agent profile 86. The agent profile database 42 is searched for an agent whose profile information matches the task profile information. In most cases, the search of the agent profile database will look for an agent having the specified experience and skills listed in the task profile. If one or more suitable agents are found 152, the particular task profile is communicated to the matching agents 154. If no matching agent is found in the agent profile database, the potential agent database 46, if used, is then searched for a match. If a suitable agent is found in the potential agent profile database 46, the qualification of the matching potential agent is completed 158. If the qualification can be completed, the task profile is communicated to the qualified agent. If, for any reason, no suitable agent is found or no potential agent can be qualified quickly enough, the lack of an acceptable agent is communicated to the customer 160, who then has the option to update the task to broaden the scope of suitable agents or remove the task. Alternatively, the customer could request the closest matching agent and select amongst them. The search of the agent profile database and the potential agent profile database for matching agents or potential agents occurs in real time and in the background while the customer is connected to the information center 16 through the interface 60. The communication to the customer of the lack of an acceptable match or the communication to the agent of a pending task profile is preferably done through the interface 60.

It is worth noting that it is preferred to use the interface 60 for substantially all of the communication between the customer, agent, and information center. In most circumstances, since the customer and agent have a particular logon I.D., the interface 60 can easily be customized for each customer and agent. In that manner, the interface 60 as viewed by a particular agent and customer will include communications relevant to that customer or agent, such as the communications relating to the lack of an acceptable agent or the communication of new or updated task profiles. These communications can take the form of simple messages or links to more detailed messages. Additionally, an e-mail can be sent directly to the customer or the agent and bypass the interface 60. That said, it is possible to use both the interface 60 and the e-mail as tools to ensure that the communication is made to the customer and the agent. Other means of communicating are also acceptable within the scope of the invention. For example, there are well-known mechanisms for using computers or e-mails to ring a beeper or pager and display a suitable message or leave a suitable voice message. All of these activities can be controlled by the interface 60 in combination with the database residing on the information center 16.

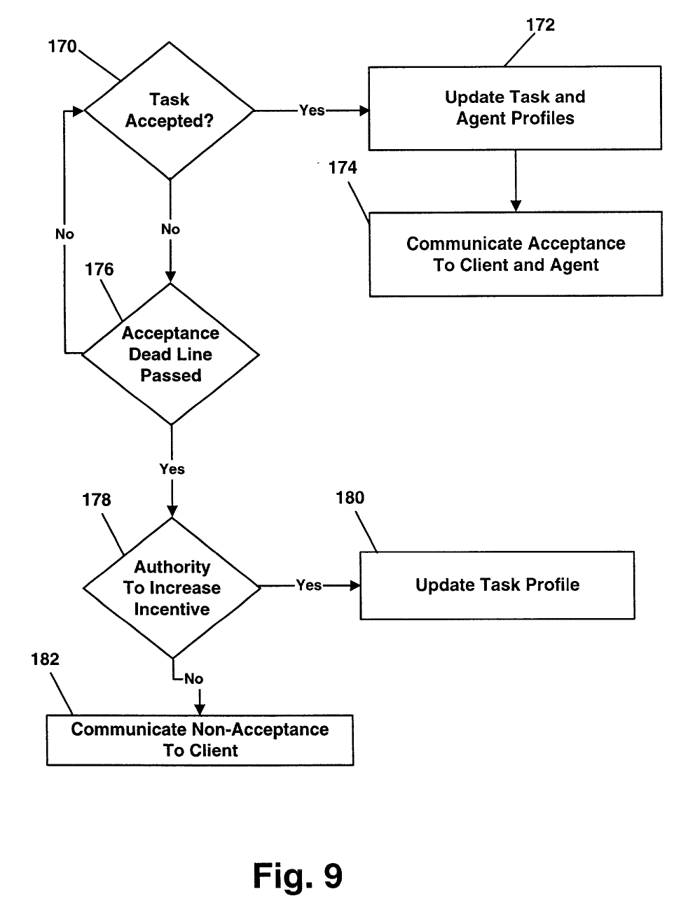

FIG. 9 illustrates the major steps in the task acceptance step 88. An initial check is conducted to determine if a particular task has been accepted by a suitable agent at step 170. If the task is accepted by a suitable agent, the corresponding task profile and agent profile are updated in the agent and task profile databases 42, 44 at step 172. The acceptance is then communicated to the customer and the agent at 174.

If the task is not accepted, the acceptance status of the task is monitored for a predetermined time that preferably corresponds to a deadline set by the customer and entered into the task profile. If the deadline for acceptance passes at step 176, then a determination is made at step 178 to see if the control center is authorized to increase the incentive for accepting the task. Since multiple agents are viewing the task, a competition to pull and complete the task will occur creating demand for the task. Preferably, the authority for increasing the incentive has already been given in the task profile by the customer. If authority to increase the incentive has been given, the task profile will be updated accordingly and the agents will then view the new incentive associated with the task. The updated task will then be communicated to the agents through the task and agent matching step 86.

If the information center has no authority to increase the incentive, the lack of acceptance is communicated to the customer at step 182. The information center may also send the task to other qualified agents that have completed tasks and are ready to receive new tasks to view. An option to the communication of non-acceptance 182 to the customer is to request from the customer the authority to increase or change the incentive offered to the agent. If this authority is granted, then the task profile is updated and redistributed to the suitable agents.

In most cases, the change in the incentive will be a change in the monetary compensation available to a particular agent for accepting and completing a task. It is within the scope of the invention for the incentive to be based on non-monetary considerations. For example, a particular customer could be a manufacturer of goods desired by the agent and a barter type arrangement can be established.

Most of the task acceptance steps are preferably conducted in the background and are not viewable by either the customer or the agent through the interface 60, except for the communications to the customer and agent through the interface 60 or the previously discussed alternative methods. It is worth noting at this juncture that all of these profiles, whether they be agent, customer, or task profiles, can contain information that is not necessarily viewable through the interface 60 to the party who did not enter the information. Some of the information in the profiles is used solely to operate the system 10 and is not displayed in the interface 60. For example, the customer's authorization to increase the incentive, the time frame for increasing the incentive, and the amount of the incentive increase, is not readily available to any agent when viewing a particular task profile. The information regarding the authority to increase incentives is used by the system 10.

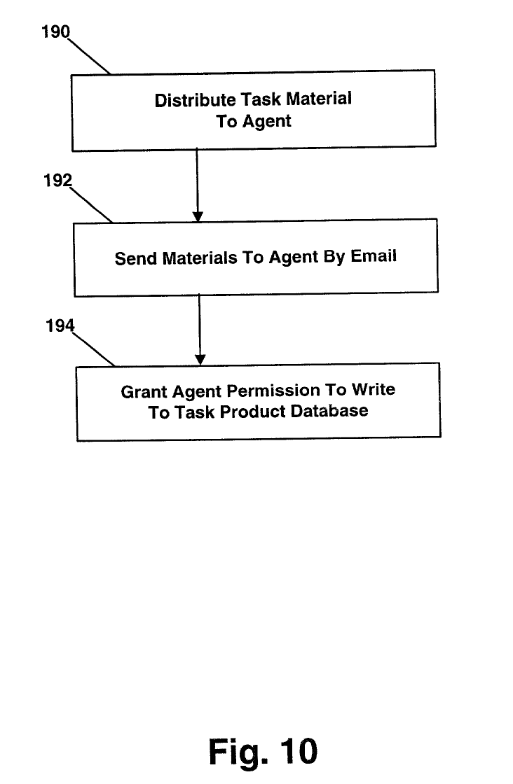

Referring to FIG. 10, once a task is accepted by a particular agent at step 88, the materials for that particular task are then distributed to the accepting agent at step 190. The distribution of the task materials can include sending the materials to the agent by e-mail as embedded text or as attachments to the e-mail at step 192. Step 192 could as easily be accomplished using regular U.S. postal mail depending on the circumstances. In step 194, the agent is granted permission to access any task or report forms housed on the database server 34, permitting the agent to complete the task by filling out forms directly on the database server 34. Again, it is within the scope of the invention for the agent to merely fill out traditional paper forms and send them back to the information center 16.

To the extent that forms are used on the database server 34, these forms typically will be web-based forms that can be easily filled out by the agent accessing the web pages through the interface 60. The completed forms are then submitted where they are saved to the task product database 50 in real time.

Examples of suitable task material include a telemarketing script, a customer list for receiving the telephonic script, and a form for tracking the results of the telephonic solicitations. These materials can be collected together as one electronic file or as multiple files. Similarly, these materials could easily be an executable program sent to the agent from the information center 16. The content and type of material is not limiting to the invention.

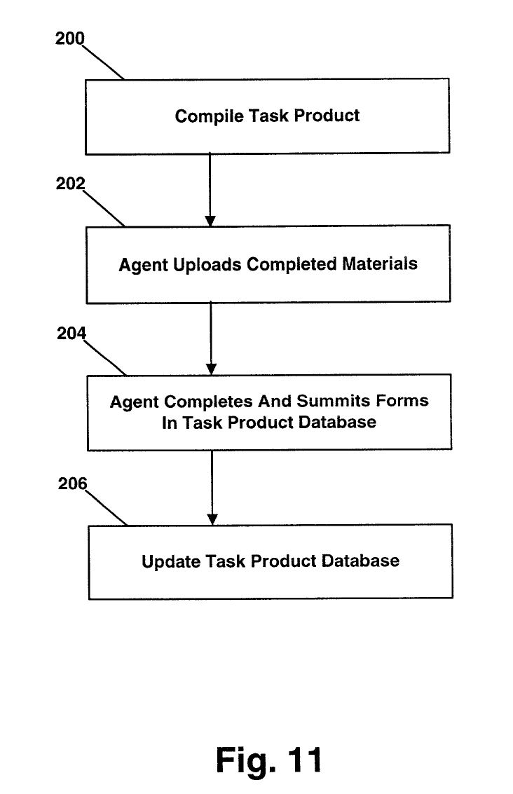

Referring to FIG. 11, once the task materials have been distributed to the accepted agent, the agent then works on the particular task and compiles the results or task product 200, which can be accessed by the customer through the interface 60. The steps of compiling the task product 200 can include the agent uploading completed materials onto the database server 34 of the information center 16 at 202, and completing and submitting forms residing on the database server 34 through the interface 60 at 204. The task product database 50 is then updated at step 206. The compiling of the task product preferably takes place through the interface 60 by the agent either submitting completed documents electronically into the task product database for retrieval by the agent. The agent can also complete the online forms, which are preferably web-based, that enter the completed task information in real time into the task product database 50, where the completed or partially completed task can be reviewed in real time by the customer through the interface 60.

The completion step can also include a review step where either or both the customer and agent complete a review of the other, which is then saved to the particular customer or agent's profile. The feedback review ensures the continued qualification of the customer's and agents.

After the task is completed, the customer is billed at step 94 for the task. If the task is time based, the agent's time on the task is summed and billed to the customer. The agent's time is preferably tracked on the particular agent's profile for that task. Upon payment by the customer for a particular agent or task, the agent is then paid at step 96, preferably by electronic funds transfer. The billing and payment steps are not essential to the invention and will not be described in greater detail.

Although the system 10 can be used for many types of tasks that require a business to use external labor force, the system is particularly well-suited for tasks where the external labor force generates a tangible product in real time and the customer desires to see the results compiled in real time. Examples of such tasks include telemarketing solicitations, sales calls and consumer surveys. For example, a telemarketing script, and customer list, along with response forms can be distributed to one or many agents through the information center. As the agents make the telemarketing calls in accordance with the customer list, the results of each call is filled out by the agent on the form. Preferably, the form is a web-based form and the agent is filling it out directly through the user interface 60, which immediately compiles the results of the telemarketing calls in real time for access and analysis by the customer.

In the consumer survey example, one or more agents accepting the task can conduct consumer surveys in the field live at various geographic locations and the results of their survey can be entered through the user interface 60 directly to the task results database for real time review by the customer. The agent or agents could easily conduct the surveys on palm-type devices or portable computers that are connected to the Internet through any means, such as direct dialing, wireless connections, etc., permitting the survey results to be compiled. As the consumer survey results are compiled, the customer can review and analyze the data in any way and manner desired through the interface 60. The customer can also download the task product results in real time for independent analysis on the customer server.

The system 10 and its method of operation are a substantial improvement over current systems of finding and aligning a suitably qualified and skilled external workforce to a particular task for a customer. The invention controls the supply and demand of the workflow distribution to the selected agent. By having a revolving task database that multiple qualified agents review, the competition for task retrieval and completion provides the client with an external distribution mechanism and the agent with an income that is derived from a flexible work environment. The invention not only accomplishes the finding of the suitable and qualified workforce and the allocation of the task to that qualified workforce, but it also retrieves the task product results completed by the agent for a particular task. Prior art attempts to align external workforces with a particular task for a customer were limited to merely putting people together in function not much differently than an electronic version of a temporary help agency. The invention goes way beyond this by permitting the real time collection and completion of the product for the task.

While the invention has been specifically described in connection with certain specific embodiments thereof, it is to be understood that this is by way of illustration and not of limitation, and the scope of the appended claims should be construed as broadly as the prior art will permit.

The present disclosure should not be construed in any limited sense other than that limited by the scope of the claims having regard to the teachings herein and the prior art being apparent with the preferred form of the invention disclosed herein and which reveals details of structure of a preferred form necessary for a better understanding of the invention and may be subject to change by skilled persons within the scope of the invention without departing from the concept thereof

I claim:

1. A system for assigning and distributing work over a computer network comprising:
a) a central internet web server acting as a central coordinating site;
b) at least one remote terminal, in communication with said central internet web server;
c) a means for transferring a two-way data stream between said central internet web server and said at least one remote terminal;
d) a first database, in communication with said central internet web server, said first database containing at least one work project description;
e) a second database, in communication with said central internet web server, said second database containing a description of at least one agent, having a set of qualifications, seeking work assignments;
f) a means for screening the set of qualifications of said at least one agent such that access to said first data base is restricted to the at least one agent who has a set of qualifications that match a set of criteria related to said at least one work project description;
g) a means for accessing said first data base by said at least one agent to review said at least one work project; and
h) a means for accepting said at least one work project by said at least one agent:

2. The system of claim 1 further comprising a means for posting a workflow script to said central internet web server from said at least one remote terminal.

3. The system of claim 1 further comprising an identification number for said at least one agent, and further whereby said identification number is associated with said at least one work project accepted by said at least one agent.

4. The system of claim 1 further comprising a means for tracking work progress in communication with said central internet web server.

5. The system of claim 1 further comprising a means for verifying the status of said at least one work project.

6. The system of claim 5 further comprising a means for making payment to said at least one agent upon completion of said at least one work project.

8. A system for assigning and distributing work over a computer network comprising:
a) a central internet web server acting as a central coordinating site;
b) a plurality of remote terminals, each of said plurality of remote terminals being in communication with said central internet web server;
c) a means for transferring a two-way data stream between said central internet web server and each of said plurality of remote terminal;
d) a first database, in communication with said central internet web server, said first database containing a plurality of work project descriptions;
e) a second database, in communication with said central internet web server, said second database containing a description of a plurality of agents seeking work assignments;
f) a means for screening the set of qualifications each of said plurality of agents such that access to said first data base is restricted to each of said plurality of agents who has a set of qualifications that match a set of criteria related to one of said plurality of work project descriptions;
g) a means for accessing said first data base by one of said plurality of agents whereby that one agent is able to review only a selection of said plurality of work projects that have a set of criteria that match the set of qualifications of that one agent;
h) a means for accepting at least one of said plurality of work projects selected for review by one of said plurality of agents; and
i) a means for locking out each of said plurality of agents from reviewing said work assignment after said one of said plurality of agents has accepted the at least one of said plurality of work projects.

9. The system of claim 8 further comprising a means for posting a workflow script to said central internet web server from said at least one remote terminal.

10. The system of claim 8 further comprising an identification number for each if said plurality of agents.

11. The system of claim 8 further comprising a means for tracking work progress in communication with said central internet web server.

12. The system of claim 8 further comprising a means for verifying the status of said at least one work project.

13. The system of claim 12 further comprising a means for making payment to said at least one agent upon completion of said at least one work project.

14. A method for assigning and distributing work over a computer network having a central internet web server acting as a central coordinating site; a plurality of remote terminals, each of said plurality of remote terminals being in communication with said central internet web server; a means for transferring a two-way data stream between said central internet web server and each of said plurality of remote terminal; a first database, in communication with said central internet web server, said first database containing a plurality of work project descriptions; a second database,, in communication with said central internet web server, said second database containing a description of a plurality of agents seeking work assignments; a means for accessing said first data base by each of said plurality of agents to review said plurality of work projects; a means for accepting at least one of said plurality of work projects by at least one of said plurality of agents; and a means for locking out each of said plurality of agents from reviewing said work assignment after said at least one of said plurality of agents has accepted said at least one of said plurality of work projects; comprising the steps of:
a) posting a plurality of work project description on the central internet web server;
b) having each of the plurality of agents review said plurality of work project descriptions;
c) having one of said set of plurality of agents accept one of said plurality of work project descriptions;
d) locking out all other agents of said set of said plurality of agents from accessing the work project description accepted by the one of said set of plurality of agents; and
e) repeating steps b-d for each work project description of said set of said plurality of work project descriptions.

15. The method of claim 14 further comprising the step of:
a) establishing a work value for the work project accepted by the one of said plurality of agents.

16. The method of claim 14 further comprising the step of making a communication between a party posting a work project on said central internet web server and an agent.

17. The method of claim 16 wherein the communication is selected from the group of: a resume of an agent's qualifications, a set of terms for performing a work project, a schedule of payments for a work project, an invoice for work completed, a status report on a work project, a partial delivery of a work project, and a final work product.

18. The method of claim 17 wherein the set of terms for performing a work project is selected from the group of: a schedule for completion of a work project, a schedule for delivery of work project components, a list of other agents assigned to a work project, and a rate of compensation for a work project.

19. The method of claim 14 further comprising the steps of:
a) obtaining a list of qualifications for each of said plurality of agents;
b) matching said list of qualifications to each of said plurality of work projects; and
c) restricting access to a set of said plurality of work projects to a set of said plurality of agents whose qualifications are matched to a scope of work defined in said set of said plurality of work projects.

20. The method of claim 14 further comprising the steps of:
a) monitoring the progress in each of said plurality of work projects;
b) making changes in an agent assigned to each of said plurality of work projects, consistent with a set of job specifications; and
c) repeating steps a and b until each of said plurality of work projects is completed.
